(19) United States
(12) Patent Application Publication
(10) Pub. No.: US 2012/0142467 A1
(43) Pub. Date: Jun. 7, 2012

(54) IDLER DEVICE

(75) Inventors: Wonseok CHANG, Hwaseong-si (KR); Jinkook KONG, Anyang-si (KR); Youngnam KIM, Hwaseong-si (KR); Bumyong PARK, Suwon-si (KR)

(73) Assignees: Hyundai Motor Company, Seoul (KR); GENERGINE CORP., Suwon-si (KR); Kia Motors Corporation, Seoul (KR)

(21) Appl. No.: 13/294,547

(22) Filed: Nov. 11, 2011

(30) Foreign Application Priority Data
Dec. 1, 2010 (KR) 10-2010-0121667

(51) Int. Cl. F16H 7/08

(52) U.S. Cl. 474/101

(57) ABSTRACT

An idler device may include first bearings rotatably supporting an idler to an idler shaft, wherein a portion of the idler may be rotatably mounted to the idler shaft, and second bearings rotatably supporting the idler shaft.

### CROSS-REFERENCE TO RELATED APPLICATIONS

The present application claims priority to Korean Patent Application Number 10-2010-0121667 filed Dec. 1, 2010, the entire contents of which application is incorporated herein for all purposes by this reference.

### BACKGROUND OF THE INVENTION

1. Field of the Invention

The present invention relates to an idler that is used to adjust tension of a belt, and more particularly, to an idler device that can be achieved at low cost and is suitable for high speed by using a double bearing.

2. Description of Related Art

In the related art, idlers that are used for vehicles are device that is disposed to apply predetermined tension to a belt after the belt is mounted in a belt and pulley assembly and is typically composed of a rotary body to reduce friction with the belt.

A bearing is needed inside the idler or on the idler shaft, similar to all other rotary bodies, in order to achieve the idler with a rotary body.

Ball bearings are generally used as the idler bearing, because axial load applied to the idler is not large, the idler usually rotates at high speeds, and the assembly is simple.

When the idler is equipped with ball bearings, the idler shaft is a hollow shaft and simply rotatably supported by a pair of ball bearings on the left and right idler shafts of the idler in the related art.

However, when the idler shaft is equipped with ball bearings in the related art and used for a belt and pulley assembly of a vehicle, since the belt and pulley assembly rotates at a high speed, the idler correspondingly rotates at a high speed, in which high-speed bearing is suitable for the bearings on the idler shafts. Accordingly, a ball bearing having higher machining accuracy of ball than common ball bearings in order to use a high-speed bearing for the ball bearing and the high-speed ball bearing is more expensive than the common ball bearings.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an idler device that can be simply assembled at a low manufacturing cost by a simple structure and can support an idler or an idler shaft to be smoothly rotated at a high speed.

In an aspect of the present invention, the idler device may include first bearings rotatably supporting an idler to an idler shaft, wherein a portion of the idler may be rotatably mounted to the idler shaft, and second bearings rotatably supporting the idler shaft.

The first bearings and the second bearings may be ball bearings.

The first bearings and the second bearings may be disposed in pairs, respectively, at left and right sides of the idler along a longitudinal axis of the idler shaft and wherein each of the second bearings may be disposed on the idler shaft in a predetermined distance from the corresponding first bearings.

The idler shaft may be a hollow shaft.

In another aspect of the present invention, an idler may be rotatably mounted on a fixed idler shaft by bearings, the bearings may include first large-diameter bearings fitted in the idler, and second bearings fitted on the idler shaft and inserted in the first bearings in a radial direction of the fixed idler shaft.

The first bearings and the second bearings may be ball bearings.

The first bearings and the second bearings may be disposed in pairs, respectively, at left and right sides of the idler along a longitudinal axis of the idler shaft.

The idler shaft may be a hollow shaft.

A rotator may be disposed between the first bearings and the second bearings.

The rotator may be integrally connected by a rotator body, wherein the first bearings may be mounted between the idler and the rotator body, wherein an portion of the idler may be rotatably mounted to the rotator, and wherein the second bearings may be mounted between the rotator body and the idler shaft in a radial direction of the fixed idler shaft.

According to the exemplary embodiments of the present invention, since a double bearing structure composed of first bearings rotatably supporting an idler to an idler shaft and second bearings rotatably supporting the idler shaft is provided, two cheap common ball bearings that can operate at middle speeds can be used for high-speed rotation of the idler, such that it is possible to achieve a simple assembly structure and reduce the manufacturing cost.

Further, when the idler shaft is fixed, small-diameter bearings are mounted on the idler shaft, large-diameter bearings having large diameters than the small-diameter bearings are mounted in the idler, in which the small-diameter bearings are fitted in the large-diameter bearings and rotators are disposed between the small-diameter bearings and the large-diameter bearings. Therefore, the number of bearings increases, while common cheap bearings that can rotate at middle speeds can be used for the small-diameter bearings and the large-diameter bearings, as compared with when one expensive bearing having high accuracy is used. Accordingly, it is possible to achieve a simple structure and decrease the manufacturing cost.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an idler device according to various exemplary embodiments of the present invention.

FIG. 2 is an idler device according to various exemplary embodiments of the present invention.

FIG. 3 is an idler device according to various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

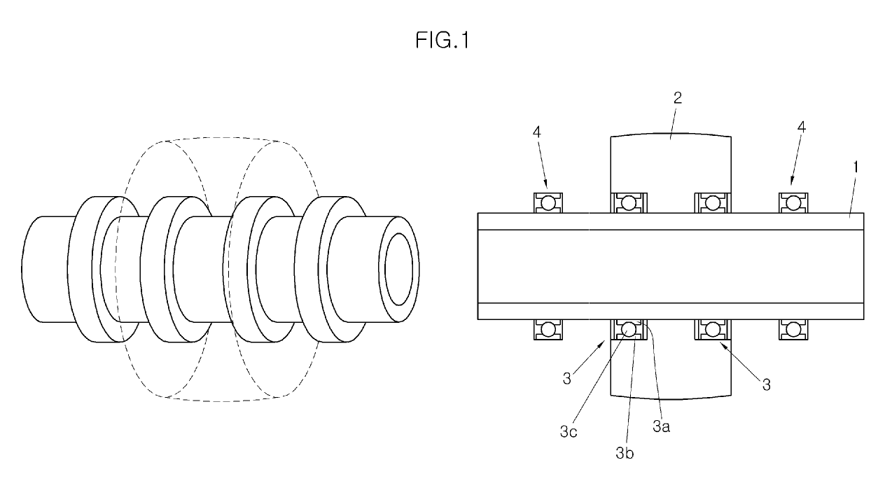

Referring to FIG. 1, an idler shaft 1 is a hollow shaft to reduce inertial force.

An idler 2 is rotatably fitted on idler shaft 1 to control tension of a belt in contact with the belt.

A pair of first bearings 3 is disposed at the left and right sides between idler 2 and idler shaft 1 to rotatably mount idler 2 on idler shaft 1.

First bearings 3 include common ball bearings that has simple structures, are easily assembled and suitable for middle speeds. The ball bearings are each composed of an inner race 3a fitted on idler shaft 1, an outer race 3b fitted in idler 2, and a plurality of balls 3c disposed between the inner race and the outer race to allow the races to relatively move.

A pair of second bearings 4 is mounted at the left and right sides of idler 2 to rotatably support idler shaft 1.

Second bearings 4 have the same ball bearing structure as the first bearings.

When the idler and the idler shafts are rotatably supported by the double ball bearing structure described above, rotation of idler 2 is transmitted to idler shaft 1 through first bearings 3 and idler shaft 1 relatively rotates to a fixing body by second bearings.

When idler 2 rotates at a high speed, idler shaft 1 rotates at a middle speed with about a half number of rotation, in which first bearings 3 carry the relative rotation between idler 2 and idler shaft 1, while the second bearings carry the relative motion of idler shaft 1 to the fixing body.

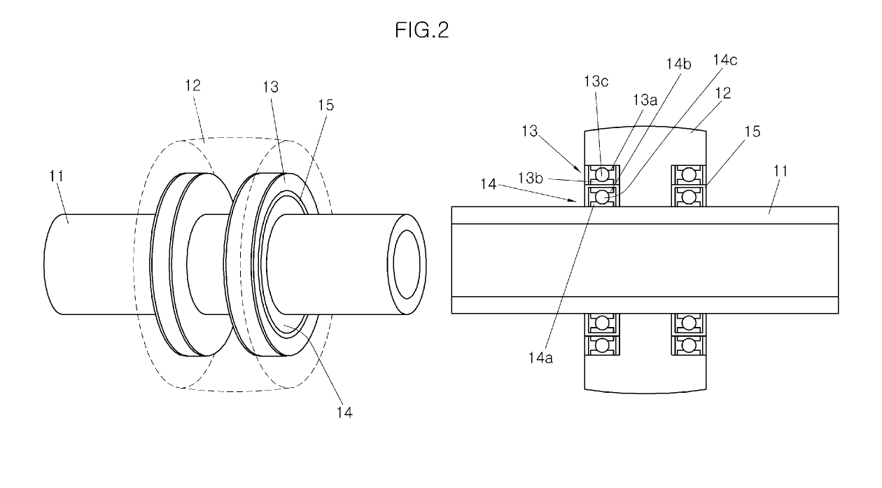

FIG. 2 shows an idler device according to a second exemplary embodiment of the present invention, in which an idler shaft 11 is a hollow shaft to reduce the inertia and an idler 12 is fitted on the idler shaft 11. Idler 12 is mounted rotatably to idler shaft 11 by two pairs of first and second bearings 13 and 14, which make a pair, respectively, at the left and right sides.

First and second bearings 13 and 14 are implemented by ball bearings and first bearings 13 are each composed of an outer race 13a fitted and fixed in the idler, an inner race 13b spaced apart from the outer race, and a plurality of balls 13c disposed between the races.

Second bearings 14 are each composed of an inner race 14a fitted on idler shaft 11, an outer face 14b, and a plurality of balls 14c. The outer race 14b of the second bearing 14 is inserted in the inner race 13b of the first bearing 13 and a rotator 15 is disposed between the outer race 14b of the second bearing 14 and the inner race 13b of the first bearing 13.

That is, first bearings 13 are large-diameter bearings having large diameters than the second bearings and the second bearings are small-diameter bearings having relatively small diameters.

Idler shaft 11 is a stator fixed to a fixing body.

In the structure described above, as idler 12 rotates at a high speed, rotator 15 rotates at a middle speed and first and second bearings carry relative motion of the idler and the rotator.

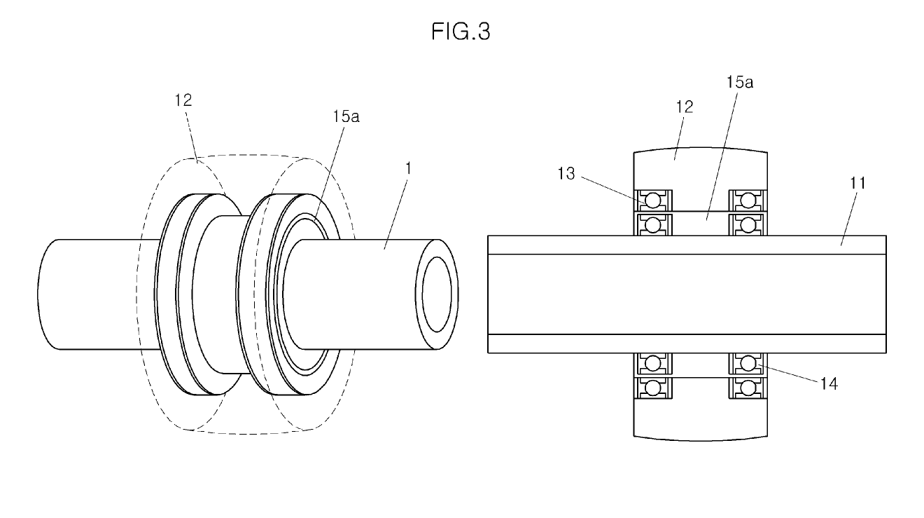

FIG. 3 shows a third exemplary embodiment of the present invention and has a difference from the second exemplary embodiment in that rotators 15 are separate members interposed between each pair of bearings in the second exemplary embodiment, while rotator body 15a connected with rotators 15 is additionally provided to increase the weight in the exemplary embodiment, and the other configurations and operations are the same.

Similar to the first exemplary embodiment, common chip ball bearings that can operate at middle speed can be used in the second exemplary embodiment and the third exemplary embodiment, such that it is possible to achieve the same effects as in the first exemplary embodiment.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. An idler device comprising:
first bearings rotatably supporting an idler to an idler shaft, wherein a portion of the idler is rotatably mounted to the idler shaft; and
second bearings rotatably supporting the idler shaft.

2. The idler device as defined in claim 1, wherein the first bearings and the second bearings are ball bearings.

3. The idler device as defined in claim 2, wherein the first bearings and the second bearings are disposed in pairs, respectively, at left and right sides of the idler along a longitudinal axis of the idler shaft and wherein each of the second bearings is disposed on the idler shaft in a predetermined distance from the corresponding first bearings.

4. The idler device as defined in claim 1, wherein the idler shaft is a hollow shaft.

5. An idler device, wherein an idler is rotatably mounted on a fixed idler shaft by bearings, the bearings include:
first large-diameter bearings fitted in the idler; and
second bearings fitted on the idler shaft and inserted in the first bearings in a radial direction of the fixed idler shaft.

6. The idler device as defined in claim 5, wherein the first bearings and the second bearings are ball bearings.

7. The idler device as defined in claim 5, wherein the first bearings and the second bearings are disposed in pairs, respectively, at left and right sides of the idler along a longitudinal axis of the idler shaft.

8. The idler device as defined in claim 5, wherein the idler shaft is a hollow shaft.

9. The idler device as defined in claim 5, wherein a rotator is disposed between the first bearings and the second bearings.

10. The idler device as defined in claim 9,
wherein the rotator is integrally connected by a rotator body;
wherein the first bearings are mounted between the idler and the rotator body;
wherein a portion of the idler is rotatably mounted to the rotator; and
wherein the second bearings are mounted between the rotator body and the idler shaft in a radial direction of the fixed idler shaft.
